(19) United States
(12) Patent Application Publication
(10) Pub. No.: US 2021/0096663 A1
(43) Pub. Date: Apr. 1, 2021

(54) ADUSTABLE HAPTIC SCROLL WHEEL

(71) Applicant: Dell Products L.P., Round Rock, TX (US)

(72) Inventors: Victor ChakMing Cheung, Singapore (SG); Peng Lip Goh, Singapore (SG)

(73) Assignee: Dell Products L.P., Round Rock, TX (US)

(21) Appl. No.: 16/583,554

(22) Filed: Sep. 26, 2019

(51) Int. Cl. G06F 3/0362; G06F 3/01

(52) U.S. Cl. CPC G06F 3/0362; G06F 3/03543; G06F 3/016

(57) ABSTRACT

A mouse scroll wheel adapts haptic response to different scroll rotation resolutions by moving a spring member between a first position aligned with a first inner circumference and a second position aligned with a second inner circumference. A selector button selects a first scroll wheel sensor increment and the spring member first position or a second scroll wheel sensor increment and the spring member second position. In one example embodiment, the first inner circumference has twelve teeth to provide haptic feedback at thirty degree wheel sensor increments and the second inner circumference has twenty-four teeth to provide haptic feedback at fifteen degree wheel sensor increments.

### BACKGROUND OF THE INVENTION

### Field of the Invention

The present invention relates in general to the field of information handling system input devices, and more particularly to an information handling system mouse adjustable haptic scroll wheel.

### Description of the Related Art

As the value and use of information continues to increase, individuals and businesses seek additional ways to process and store information. One option available to users is information handling systems. An information handling system generally processes, compiles, stores, and/or communicates information or data for business, personal, or other purposes thereby allowing users to take advantage of the value of the information. Because technology and information handling needs and requirements vary between different users or applications, information handling systems may also vary regarding what information is handled, how the information is handled, how much information is processed, stored, or communicated, and how quickly and efficiently the information may be processed, stored, or communicated. The variations in information handling systems allow for information handling systems to be general or configured for a specific user or specific use such as financial transaction processing, airline reservations, enterprise data storage, or global communications. In addition, information handling systems may include a variety of hardware and software components that may be configured to process, store, and communicate information and may include one or more computer systems, data storage systems, and networking systems.

Information handling systems generally process information with a processor and present output as visual images at a display. An operating system executing on the processor manages processing by applications based upon inputs made by an end user through an input device. For example, an end user selects an application widow by a mouse or other pointing device input and the operating system directs subsequent mouse or keyboard inputs to that application. A mouse input is typically represented by the operating system as an arrow that moves across the displayed information based upon end user inputs at the mouse. Typically, the mouse slides across the surface of a desktop and translates position changes into cursor movement. In some cases a mouse has a trackball that the user rotates to move the cursor instead of moving the mouse body. Generally, a mouse includes two or three input buttons on its upper surface that accept “click” inputs. The operating system interprets the inputs as left, right or center clicks at the location of the cursor on the display. Applications typically leverage this operating system interpretation to offer end users specific input functionality based on the type of click and mouse cursor position. In addition to cursor control and input buttons, a mouse typically also provides a scroll wheel input device. A scroll wheel generally rotates by an end user input made to the wheel at the upper mouse surface. Generally, a scroll wheel input scrolls through information presented in a window that the cursor has activated, such as scrolling through a web page.

A mouse is a typical input device for common office applications, such as word processing, spreadsheet and web browsing applications. In these applications, a mouse provides an intuitive input device that simplifies end user interactions, such as with point and click functions. A mouse also finds use in other types of applications that take advantage of the flexibility available through the operating system to apply inputs in alternative ways. For instance, many gaming applications leverage mouse inputs to interact with gaming functions. In such gaming applications, mouse movements, clicks and scrolls may have application-specific meanings driven by inputs needed at the game. For instance, making a mouse a game input device allows an end user to adapt an information handling system to play games where more typical gaming input devices are not available, such as an office information handling system that does not have a joystick. In such situations, end users tend to have varying needs for mouse sensitivity. For instance, the precision offered by a mouse movement may be adjusted so that an end user can drive more precise input selections at a game. As an example, a mouse's sensitivity may tie large mouse movements to small cursor movements so an end user can more precisely place the cursor. As an alternative, a mouse's sensitivity may tie small movements to larger cursor movements so an end user can rapidly move the cursor around a display with relatively small hand movements.

One difficulty with mouse sensitivity is adjusting scroll wheel movements to end user expectations. Generally, scroll wheels include a haptic feedback that indicates to an end user an amount of scroll wheel rotation, such as a click every 15 degrees of rotation. End users rely upon the audible and touch haptic feedback to accurately input at a scroll wheel and prevent miss-scrolls. A typical scroll wheel provides a 24 count resolution of haptic feedback with a click provided every 15 degrees of resolution. Some end users have multiple mouse devices to provide different resolutions of haptic feedback, such as the Zowie EC2-A with a 16 count resolution. Changing physical devices or changing out physical components within devices is not convenient and adds cost to the end user. Some mouse devices, such as the Logitech G903, alternate between having detents and having a free wheel that does not include detents with selection of the no-detente operating mode by a push-push button located at the mouse upper surface adjacent the scroll wheel. Some mouse devices, such as the Razer Basilisk, changes the size of the scroll wheel haptic feedback with an adjustable internal wheel detente torque force, however, scroll wheel resolution remains unchanged.

### SUMMARY OF THE INVENTION

Therefore, a need has arisen for a system and method which adjusts a mouse scroll wheel haptic response between different resolutions.

In accordance with the present invention, a system and method are provided which substantially reduce the disadvantages and problems associated with previous methods and systems to adjust a mouse wheel haptic response. A mouse scroll wheel haptic feedback device provides multiple resolutions of scroll wheel rotation by moving a spring member between a first position aligned with a first set of teeth at a first circumference of the scroll wheel and a second position aligned with a second set of teeth at a second circumference of the scroll wheel. Rotational increments reported by the mouse adjust with haptic feedback resolution that inform an end user of scroll wheel inputs by scroll wheel rotation of the increments.

More specifically, an information handling system processes information with a processor and memory that cooperate to execute instructions based upon inputs provided from an end user. A mouse accepts end user inputs for communication with the processor, such as by translating movement of the mouse to movement of a cursor presented at a display, presses of input buttons on the mouse as inputs related to a graphical user interface, and scroll of a scroll wheel to move content presentation within a graphical user interface. The mouse has a resolution selection button that interfaces with a scroll wheel rotation sensor and haptic device to select between plural scroll wheel resolutions. For example, a spring member extends to a first position against a first set of teeth formed at a first circumference within the scroll wheel for a first resolution of haptic feedback or extends to a second position against a second set of teeth formed at a second circumference within the scroll wheel for a second resolution of haptic feedback. The resolution selection button adjusts the sensitivity of an electro-mechanical sensor that tracks scroll wheel motion to match haptic feedback to the resolution. For instance, in one example embodiment, a first set of twelve evenly spaced teeth corresponds to a rotation resolution of thirty degrees and a second set of evenly spaced teeth corresponds to a rotation resolution of fifteen degrees.

The present invention provides a number of important technical advantages. One example of an important technical advantage is that a mouse scroll wheel adjusts between different resolutions of physical haptic response. An end user can, in essence, shift gears between high and low resolutions with a button press or slide at a mouse. The change in resolution relates to physical haptic feedback at the scroll wheel so the end user senses more or fewer clicks for a given scroll wheel rotation. Further adjustments of sensitivity for scroll wheel inputs provides the end user with a range of haptic feedbacks and input precisions from which to select.

### BRIEF DESCRIPTION OF THE DRAWINGS

The present invention may be better understood, and its numerous objects, features and advantages made apparent to those skilled in the art by referencing the accompanying drawings. The use of the same reference number throughout the several figures designates a like or similar element.

FIG. 1 depicts an information handling system configured to accept end user inputs from a mouse having a scroll wheel;

FIG. 2 depicts an exploded upper perspective view of a mouse having a scroll wheel;

FIG. 3 depicts an upper rear perspective of a mouse control board having an electro-mechanical sensor to determine scroll wheel rotation;

FIG. 4 depicts a lower rear perspective of the mouse scroll wheel resolution selection button;

FIG. 5 depicts a side view of a scroll wheel having first and second sets of haptic feedback teeth; and

FIG. 6 depicts an upper side perspective view of a scroll wheel haptic feedback device with plural selectable resolutions.

### DETAILED DESCRIPTION

An information handling system mouse scroll wheel provides haptic feedback at plural resolutions to adapt to scroll wheel inputs at the information handling system. For purposes of this disclosure, an information handling system may include any instrumentality or aggregate of instrumentalities operable to compute, classify, process, transmit, receive, retrieve, originate, switch, store, display, manifest, detect, record, reproduce, handle, or utilize any form of information, intelligence, or data for business, scientific, control, or other purposes. For example, an information handling system may be a personal computer, a network storage device, or any other suitable device and may vary in size, shape, performance, functionality, and price. The information handling system may include random access memory (RAM), one or more processing resources such as a central processing unit (CPU) or hardware or software control logic, ROM, and/or other types of nonvolatile memory. Additional components of the information handling system may include one or more disk drives, one or more network ports for communicating with external devices as well as various input and output (I/O) devices, such as a keyboard, a mouse, and a video display. The information handling system may also include one or more buses operable to transmit communications between the various hardware components.

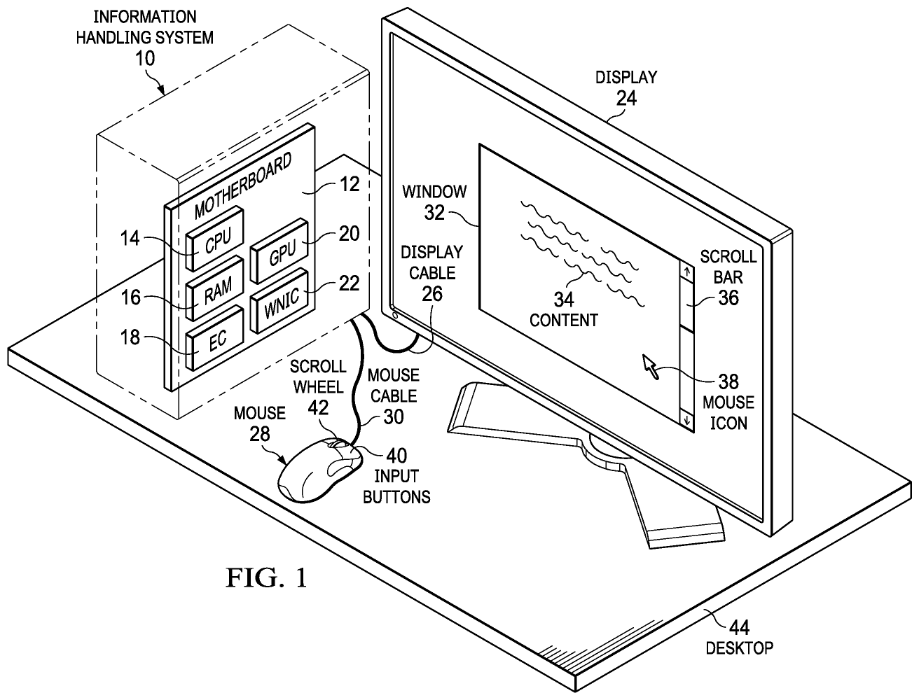

Referring now to FIG. 1, an information handling system 10 is depicted configured to accept end user inputs from a mouse 28 having a scroll wheel 42. Information handling system 10 processes information with processing components interfaced through a motherboard 12. For example, a central processing unit (CPU) 14 executes instructions of an operating system and/or applications stored in random access memory (RAM) 16 to generate information for presentation to an end user. An embedded controller (EC) 18 manages physical systems at information handling system 10, including interactions with inputs devices, such as keyboard and mouse 28. A graphics processing unit (GPU) 20 interfaces with CPU 14 and RAM 16 to adapt information for presentation at a display 24, such as by generating pixel values applied by display 24 to create visual images and communicated through a display cable 26. In the example embodiment, display 24 presents information window 32 as content 34 that an end user can interact with by mouse 28 through a scroll bar 36 and mouse icon 38.

In a typical environment, an end user moves mouse 28 across a desktop 44 to move mouse icon 38 around display 24 in a symmetric manner with communication through a mouse cable 30 or wireless communications through a wireless network interface card (WNIC) 22. An end user may select inputs at information handling system 10 by placing mouse icon 38 over content 34 and pressing input buttons 40. As an example, placing mouse icon 38 over scroll bar 36 and pressing left input button 40 will command a scroll through content 34. In addition, an end user may place mouse icon 38 over content 34 and rotate a scroll wheel 42 to scroll through content 34. Rotation of scroll wheel 42 translates predetermined amounts of rotational movement into incremental movement of content 34. For instance, in one example embodiment thirty degrees of rotation of scroll wheel 42 results in one incremental scroll command to content 34, which equals one mouse click on scroll bar 36. To aid in end user interactions with scroll wheel 42, a haptic feedback is provided at each incremental scroll command that the end user can feel at the finger that rotates scroll wheel 42. Although this example describes a typical desktop 44 interaction, such as in an enterprise environment, scroll wheel 42 incremental inputs may be used by various applications in different ways, such as to support gaming.

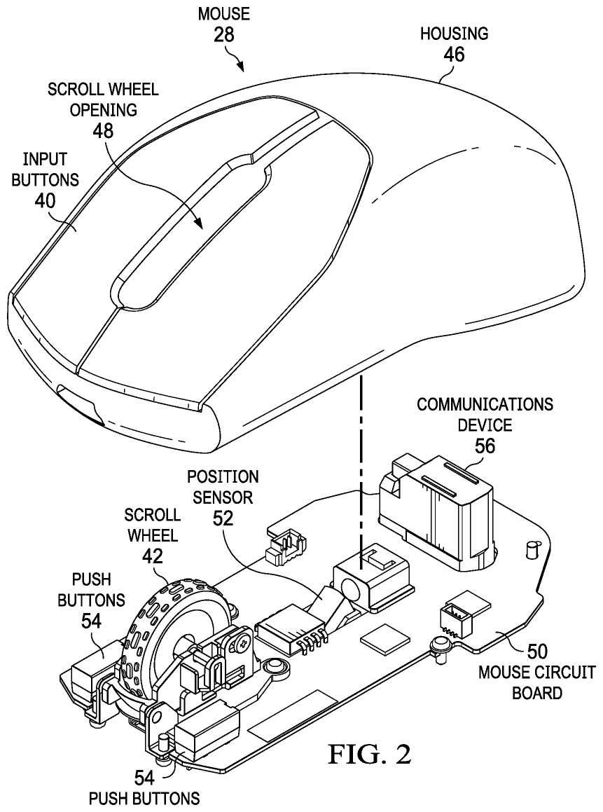

Referring now to FIG. 2, an exploded upper perspective view depicts mouse 28 having a scroll wheel 42. A housing 46 formed to fit under a hand includes a scroll wheel opening 48 through which scroll wheel 42 fits and buttons 40 that accept end user click inputs. Housing 46 fits over a mouse circuit board 50 having a bottom surface configured to slide along a desktop 44. Push buttons 54 integrated in mouse circuit board 50 detect presses at input buttons 40 of housing 46. A position sensor 52, such as an optical sensor, is exposed to desktop 44 through mouse circuit board 50 to detect a vector of motion of mouse 28 for communication to an information handling system through a communications device 56, such as a USB interface or a wireless interface like Bluetooth.

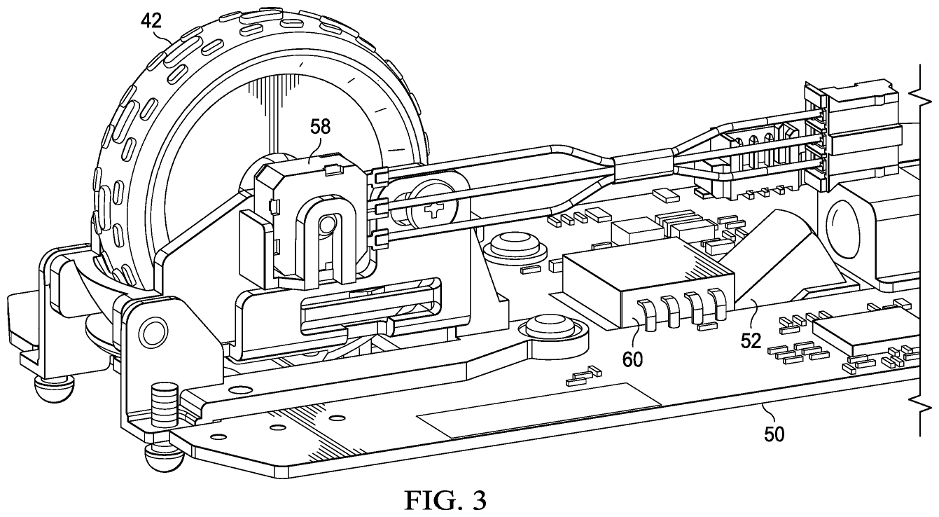

Referring now to FIG. 3, an upper rear perspective depicts mouse circuit board 50 having an electro-mechanical rotation sensor 58 to determine scroll wheel rotation. Scroll wheel 42 has a height that extends an upper portion out of housing 46 for rotational access by an end user finger. Rotation sensor 58 detects rotation in increments, such as every fifteen or thirty degrees and reports the rotation to an information handling system. For instance, a processor 60 coupled to mouse circuit board 50 may manage interactions through a communications device based upon end user settings as described in greater detail below.

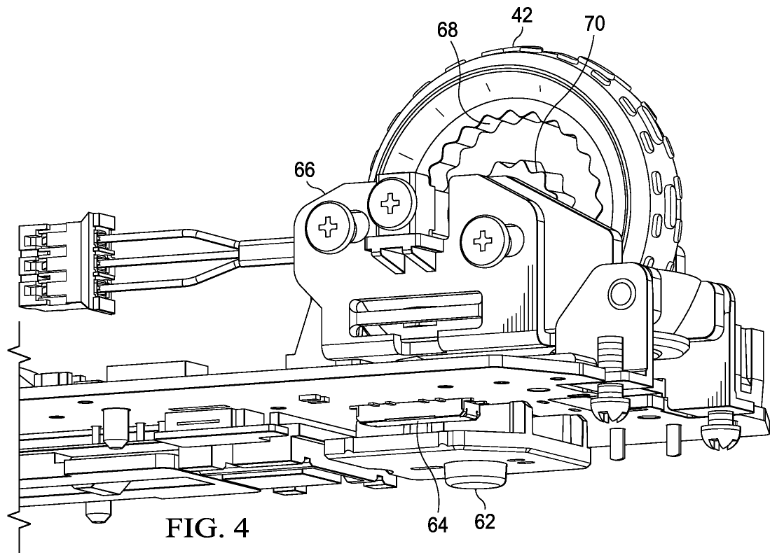

Referring now to FIG. 4, a lower rear perspective view depicts mouse 28 scroll wheel 42 resolution selection button 62. Resolution selection button 62 adapts mouse inputs by changing the resolution sensed at scroll wheel 42 for each reported increment and the haptic feedback felt by an end user. In the example embodiment, at each scroll wheel 42 increment reported by scroll wheel rotation sensor 58, haptic device 66 provides a haptic feedback that an end user can feel, such as a vibration translated through scroll wheel 42. Haptic device 66 generates the haptic feedback by interacting with one of a high resolution set of outer circumference teeth 68 or low resolution inner circumference teeth 70. An end user selects interaction with high or low resolution teeth by moving resolution selection button 62 forwards or backwards. In addition to changing selection of interaction with high or low resolution teeth, moving resolution selection button 62 adjusts incremental reporting of wheel scroll rotation by detection of the switch position with an electrical switch 64. Electrical switch 64 reports selection high or low scroll wheel resolution selection to processor 60, which adjusts the amount of scroll wheel movement associated with reporting a scroll wheel increment.

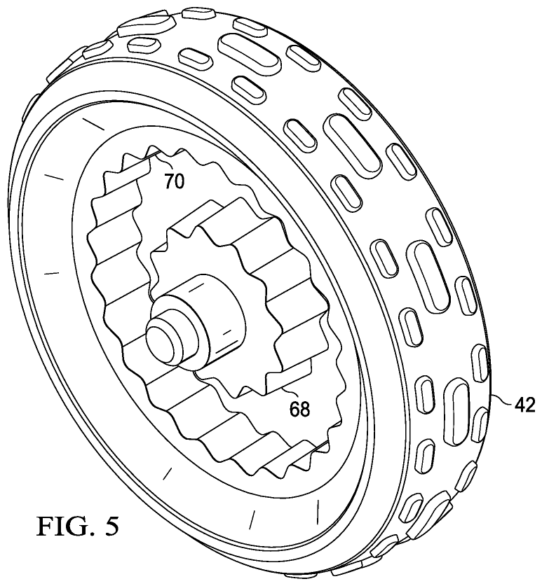

Referring now to FIG. 5, a side view depicts scroll wheel 42 having first and second sets of haptic feedback teeth, as partially shown by FIG. 4. In the example embodiment, both high resolution outer circumference teeth 68 and low resolution inner circumference teeth 70 are evenly spaced and with substantially the same size and shape. High resolution haptic feedback is provided by twenty-four evenly spaced teeth that provide a haptic response, such as a vibration, at each fifteen degrees of rotation of scroll wheel 42. Thus, in the example embodiment having one scroll increment reported for each haptic response, a scroll increment is reported at each fifteen degrees of rotation. Low resolution haptic feedback is provided by twelve evenly spaced teeth that provide the haptic response at each thirty degrees of rotation of scroll wheel 42. Thus, in the example embodiment having one scroll increment reported for each haptic response, a scroll increment is reported at each thirty degrees of rotation of scroll wheel 42. In alternative embodiments, other forms of haptic feedback may be used, such as different sized teeth or an intermediate position where the teeth do not generate a haptic response. Further, incremental scroll wheel movement may be reported at different values than the haptic response. Although the example embodiment depicts two haptic response increments that each relate to a scroll wheel incremental movement report, in alternative embodiments, each haptic response may relate to multiple scroll wheel increment reports, such as by an end user configuration of scroll wheel sensitivity.

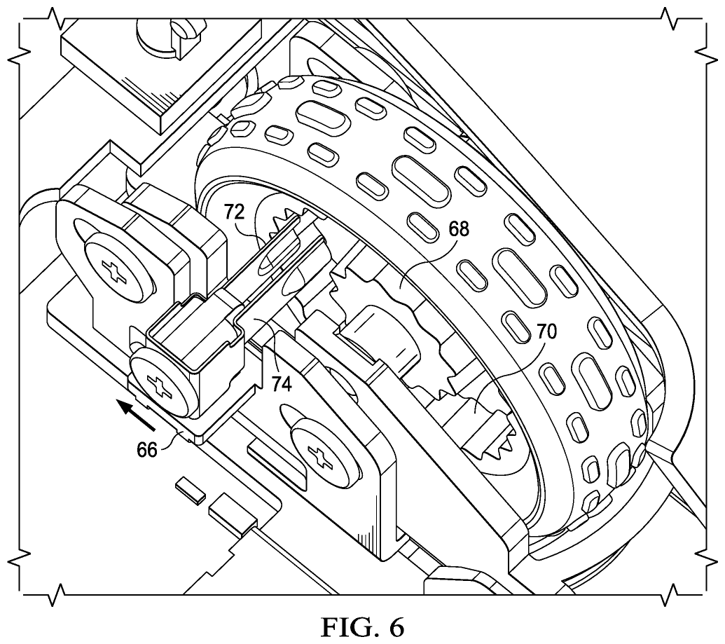

Referring now to FIG. 6, an upper side perspective view depicts a scroll wheel haptic device 66 with plural selectable resolutions. Haptic device 66 extends a spring member 72 out from a sliding base so that a spring member head 74 disposed at the end of spring member 72 aligns with high resolution outer circumference teeth 68 (as shown) or low resolution inner circumference teeth 70. For instance, resolution selection button 62 translates movement to the base housing of haptic device 66, which slide relative to a fixed position of scroll wheel 42 so that spring member 72 moves between the high and low resolution positions. Spring member 72 head 74 has a semicircular shape that fits within each tooth and biases scroll wheel 42 to a neutral position so that subsequent movement of scroll wheel 42 will generate a scroll increment that corresponds roughly with generation of a haptic response as spring member 72 falls into an adjacent tooth following an incremental movement. In the position shown, spring member 72 provides a high resolution haptic response with processor 60 reporting a scroll wheel increment at every fifteen degrees of scroll wheel rotation. To provide a low resolution haptic response, haptic device 66 slides spring member 72 inward toward the rotation axis of scroll wheel 42 to interact with low resolution inner circumference teeth 70. To support a haptic response in both positions, spring member head 74 has a semicircular shape on both opposing sides.

The example embodiment provides scroll wheel incremental output and haptic response at one of fifteen or thirty degree of rotational movement of scroll wheel 42 based upon selection of a forward or rear position of resolution selection button 62. Alternative embodiments may apply alternative mechanisms and sensors for detecting scroll wheel position and outputting a haptic response. For instance, in one alternative embodiment, spring member 72 may slide to a neutral position that does not contact any teeth. In another alternative embodiment, automated application of end user resolution preferences may be supported with an actuator that moves haptic device 66 between high and low resolution positions, such as a solenoid that is remotely commanded by an information handling system to select high or low resolution haptic feedback. In another alternative embodiment, haptic device 66 may include a switch that detects each haptic feedback, such as by movement translated from spring member 72, to include the scroll wheel position sensor within haptic device 66. In various embodiments, different amounts of angular resolution for the haptic response may be provided by changing the number of teeth and circumference of the teeth with which spring member 72 interacts.

Although the present invention has been described in detail, it should be understood that various changes, substitutions and alterations can be made hereto without departing from the spirit and scope of the invention as defined by the appended claims.

1. An information handling system comprising:
a processor operable to execute instructions that process information;
a memory interfaced with the processor and operable to store the instructions and information;
an embedded controller interfaced with the processor and operable to communicate with peripheral input devices; and
a mouse interfaced with the embedded controller, the mouse operable to accept end user inputs and communicate the end user inputs to the embedded controller, the mouse having a scroll wheel configured to rotate, a scroll wheel sensor configured to report scroll wheel rotation to the embedded controller, and a haptic device interfaced with the scroll wheel, the haptic device having a first position aligned to create a haptic feedback at a first rotation increment of the scroll wheel and a second position aligned to create a haptic feedback at a second rotation increment of the scroll wheel;
wherein the scroll wheel sensor interfaces with the haptic feedback selector to report a scroll wheel increment at each haptic feedback of a spring member and one of the first or second set of teeth based upon the haptic feedback selector button position.

2. The information handling system of claim 1 wherein the haptic device further comprises:
a first set of teeth formed at a first circumference of the scroll wheel;
a second set of teeth formed at a second circumference of the scroll wheel; and
a spring member selectively aligned with the first set of teeth at the first position or second set of teeth at the second position.

3. The information handling system of claim 2 wherein the first set of teeth is twelve evenly spaced teeth and the second set of teeth is twenty-four evenly spaced teeth.

4. The information handling system of claim 2 further comprising:
a spring member housing sliding between the position and the second position; and
a haptic feedback selector button accessible at an external surface of the mouse and interfaced with the spring member housing, the haptic feedback selector sliding the spring member housing between the first position and the second position.

5. (canceled)

6. The information handling system of claim 1 wherein the first position has a thirty degree of rotation scroll wheel increment and the second position has a fifteen degree of rotation scroll wheel increment.

7. The information handling system of claim 6 wherein the scroll wheel encoder comprises an electro-mechanical encoder disposed at a side of the scroll wheel opposite the first and second set of teeth.

8. The information handling system of claim 6 wherein the spring member forms an indent shaped to fit within a groove defined by the first and second set of teeth.

9. The information handling system of claim 8 wherein:
the first set of teeth are formed at a first diameter of the scroll wheel;
the second set of teeth are formed at a second diameter of the scroll wheel;
the spring member housing slides between a position aligned with the first diameter and the second diameter; and
the first and second set of teeth have substantially the same size to form substantially the same groove.

10. A method for adjusting mouse scroll wheel haptic feedback, the method comprising:
aligning a spring member with a first circumference of the scroll wheel;
aligning the spring member with a second circumference of the scroll wheel;
generating haptic feedback by engagement of the spring member and scroll wheel when the scroll wheel rotates;
reporting a scroll wheel increment from the mouse to an information handling system at a first angular resolution when the spring member aligns with the first circumference; and
reporting a scroll wheel increment from the mouse to the information handling system at a second angular resolution when the spring member aligns with the second circumference.

11. The method of claim 10 further comprising:
forming a first set of teeth at the first circumference, the first set of teeth engaging with the spring member when the spring member aligns with the first circumference; and
forming a second set of teeth at the second circumference, the second set of teeth engaging with the spring member when the spring member aligns with the second circumference.

12. The method of claim 11 further comprising:
moving a switch at the mouse exterior surface between a first position and a second position;
translating the moving the switch to move the spring member between aligning with the first circumference at the first position and aligning with the second circumference at the second position; and
translating the moving the switch to select a first scroll wheel sensitivity when the spring member aligns with the first circumference and a second scroll wheel sensitivity when the spring member aligns with the second circumference.

13. The method of claim 12 wherein:
the first circumference has twelve evenly spaced teeth that provide a haptic feedback every thirty degrees of rotation; and
the second circumference has twenty-four teeth that provide a haptic feedback every fifteen degrees of rotation.

14. The method of claim 13 wherein:
the first scroll wheel sensitivity provides the scroll wheel rotation increment to the information handling system every thirty degrees of rotation; and
the second scroll wheel sensitivity provides the scroll wheel rotation increment to the information handling system every fifteen degrees of rotation.

15. The method of claim 10 further comprising:
detecting the scroll wheel increment based upon movement of the spring member; and
reporting each scroll wheel increment substantially simultaneously with the generating haptic feedback.

16. A mouse comprising:
a housing having a bottom surface configured to rest on a desktop and an upper surface configured for grasp by a hand, the housing having a scroll wheel opening in the upper surface; and
a scroll wheel extending partially through the scroll wheel opening and accepting rotational inputs by an end user; and
a haptic device interfaced with the scroll wheel, the haptic device having a first position associated with a first haptic response at each first rotational movement of the scroll wheel and a second position associated with a second haptic response at each second rotational movement of the scroll wheel;
a scroll wheel sensor operable to detect predetermined increments of scroll wheel rotation including at least a first scroll wheel sensor increment and a second scroll wheel sensor increment; and
a communication medium interfaced with the scroll wheel sensor and operable to communicate the detected predetermined increments to an information handling system at each of the first or second scroll wheel sensor increments.

17. (canceled)

18. The mouse of claim 16 further comprising:
a selector button disposed at the bottom surface and interfaced with the haptic device and the scroll wheel sensor, the selector button moving between a first position and a second position;
wherein:
the selector button first position selects the haptic device first position and a first scroll wheel sensor increment; and
the selector button second position selects the haptic device second position and a second scroll wheel sensor increment.

19. The mouse of claim 18 wherein the haptic device further comprises:
a first ring of teeth at a first circumference of the scroll wheel;
a second ring of teeth at a second circumference of the scroll wheel; and
a spring member interfaced with the selector button to move between a first position aligned with the first circumference and a second position aligned with the second circumference.

20. The mouse of claim 19 wherein:
the first ring of teeth comprises twelve evenly spaced teeth;
the first scroll wheel sensor increment comprises thirty degrees;
the second ring of teeth comprises twenty-four evenly spaced teeth; and
the second scroll wheel sensor increment comprises fifteen degrees.
